(19) United States
(12) Patent Application Publication
(10) Pub. No.: US 2009/0319322 A1
(43) Pub. Date: Dec. 24, 2009

(54) INTERNATIONAL DIARY SYSTEM

(76) Inventor: Il Kyoo Lee, Gyeonggi-do (KR)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/438,976

(22) PCT Filed: Sep. 2, 2007
(86) PCT No.: PCT/KR2007/004324

§ 371 Date: Feb. 26, 2009

(30) Foreign Application Priority Data
Sep. 7, 2006 (KR) 10-2006-0086358
Oct. 16, 2006 (KR) 10-2006-0100365

(51) Int. Cl. G06Q 10/00; G06F 17/30; G09G 5/00; G06Q 50/00

(52) U.S. Cl. 705/8; 707/1; 345/581; 707/104.1; 707/E17.005

(57) ABSTRACT

The present invention relates to an international diary system. More particularly, the present invention provides a means to store and manage necessary informations related to international business or overseas trip using a calendar showing national holidays by country, thereby expanding utilization of overseas schedule management.

The present invention of an international diary system comprises an input unit for a user to select a frame and input data; a memory to store a international diary program and data inputted by a user, including a first database to store yearly, monthly, weekly, and daily calendars with a mark of national holidays by country and inputted schedule, and a second database to store information on business travel of a user; a control unit to execute said program and retrieve data called for by a user from said memory; and a display unit to display said retrieved data on the screen.

### TECHNICAL FIELD

The present invention relates to an international diary system. More particularly, the present invention provides a means to store and manage necessary informations related to international business or overseas trip using a calendar showing national holidays of each country, thereby expanding utilization of overseas schedule management.

### BACKGROUND ART

A diary is a medium to record daily schedule or journal, and used by many office workers or businessmen to take notes of various informations or instructions or to carry out or achieve efficient management of business plans. Conventional diaries basically have calendars including the past and the coming years with national holidays marked, and sections to note down a short day-by-day memo therein and sections to keep personal information such as phone numbers, addresses, etc. likely shown in name cards. Such a diary has drawbacks in view of convenience for businessmen or travelers who have to often take overseas trips, for it does not have a function necessary to manage daily agenda and administrate business plan such as providing information of national holidays of each country.

On the other hand, a laptop computer, a personal digital (or data) assistant (PDA) or a mobile handset has an installed basic schedule management program, and the users are getting more who install more functional program according to their necessities. Conventional schedule management program, however, has the main drawback in that it does not provide information on national holidays of each country and a necessary function for business management, thereby demanding to additionally carry a laptop computer, a PDA, or a mobile handset with global roaming service provided.

### TECHNICAL PROBLEM

The present invention has been made in an effort to solve the above problems in the prior art, and an object of the present invention is to provide a means capable of storing and managing necessary information for overseas business and travel abroad using calendars including national holidays of each country, thereby improving the utilization of global schedule management.

Another object of the present invention is to provide a medium to mark or record indispensable information for global business and overseas travel, thereby making it possible to make use of necessary information with speed and convenience and to promote comfortable and safe business trip and travel abroad.

### TECHNICAL SOLUTION

The above object of the present invention is accomplished by an international diary system which comprises an input unit for a user to select a frame and input data; a memory to store a international diary program and data inputted by a user, including a first database to store yearly, monthly, weekly, and daily calendars with a mark of national holidays by country and inputted schedule, and a second database to store information on business travel of a user; a control unit to execute said program and retrieve data called for by a user from said memory; and a display unit to display said retrieved data on the screen.

Another object of the present invention is accomplished by an international diary which comprises a monthly view section which includes a date display portion and a national holiday display portion in each corresponding date section; and a weekly view section which includes a date display portion and a national holiday display portion in each corresponding date section, wherein said date display portion is possible to have an indicator for identifying a holiday by country and said national holiday display portion is possible to have at least one of a national flag and a name of the holiday.

### ADVANTAGEOUS EFFECTS

Accordingly, the present invention of an international diary system has advantages in that it can improve the utilization of global schedule management by providing a means capable of storing and managing necessary information for overseas business and travel abroad using calendars with national holidays by country.

In addition, the present invention is advantageous in that it can make use of information with speed and convenience and promote a comfortable and safe business trip and overseas travel by providing a medium to mark or record indispensable information for global business and travel abroad.

### DESCRIPTION OF DRAWINGS

FIG. 1 is a diagram illustrating an embodiment according to the present invention;

FIG. 2 is a main frame according to an embodiment of the present invention;

FIG. 3 is a frame of a yearly view tab according to an embodiment of the present invention;

FIG. 4 is a frame of a monthly view tab according to an embodiment of the present invention;

FIG. 5 is a frame of a weekly view tab according to an embodiment of the present invention;

FIG. 6 is a frame of a daily view tab according to an embodiment of the present invention;

FIG. 7 is a frame of an entry & departure information tab according to an embodiment of the present invention;

FIG. 8 is a frame of a hotel information tab according to an embodiment of the present invention;

FIG. 9 is a frame of a business travel diary tab according to an embodiment of the present invention;

FIG. 10 is a frame of a business travel expense records tab according to an embodiment of the present invention;

FIG. 11 is an example of a monthly view section according to another embodiment of the present invention;

FIGS. 12 to 13 are examples of a weekly view section according to another embodiment of the present invention;

FIG. 14 is an example of a yearly view section according to another embodiment of the present invention;

FIG. 15 is an example of a hotel information section according to another embodiment of the present invention;

FIG. 16 is an example of a business travel diary section according to another embodiment of the present invention;

FIG. 17 is an example of an entry & departure information section according to another embodiment of the present invention;

FIG. 18 is an example of an embassies & airlines information section according to another embodiment of the present invention;

FIG. 19 is an example of a KOTRA Korea Trade Centers information section according to another embodiment of the present invention; and

FIG. 20 is an example of a national central & local government information section according to another embodiment of the present invention.

### DESCRIPTION ON THE MAIN REFERENCE NUMERALS

| | |
|---|---|
| 11: input unit | 12: memory |
| 13: control unit | 14: display unit |
| 15: first database | 16: second database |

### Mode for Invention

The terms and the words used in the specification and the claims should not be limitedly construed with ordinary or lexical meaning. Rather, they should be construed with the meanings and the conceptions according to the idea of the present invention, abiding by the principle that an inventor can properly define the conception of terms so as to describe his or her own invention with the best manner.

While the present invention has been described with reference to particular illustrative embodiments, it is not to be restricted by the embodiments but only by the appended claims. It is to be appreciated that those skilled in the art can change or modify the embodiments without departing from the scope and spirit of the present invention.

Hereinafter, the preferred embodiments of the present invention will be described in detail with reference to the accompanying drawings.

FIG. 1 is a diagram illustrating an embodiment according to the present invention. Referring to FIG. 1, the present invention desirably comprises an input unit 11 for a user to input data, a memory 12 to store each data, a control unit 13 to retrieve data stored in the memory and overall controlling the system, and a display unit 14 to provide a display to a user.

The input unit 11 is used for a user to select a display or input data, and comprises at least one of a keyboard, a mouse, a keypad, a touchpad and a touchscreen.

The memory 12 is to store programs and data inputted by a user, and includes a first database 15 and a second database 16.

The first database 15 stores national calendars of each country by year, month, week and day, which includes a national holidays view. In addition, it stores a schedule inputted by a user, interconnects the schedule to monthly, weekly, and daily calendars, and provides the schedule on a date when called for by a user.

The second database 16 stores useful information for international business and overseas travel, which can be inputted and modified by a user. Such information includes entry and departure information including flight's origin/destination, date/time of departure/arrival, flight number, gate, seat number and memo; hotel information including duration of the staying, address, telephone number, facsimile number, reservation number and memo; business travel diaries including date of a business travel, meeting partner's name, meeting place and agenda; and business travel expense records for calculating the business travel expenses.

The control unit 13 executes a program stored in the memory 12, calculates local time of each country, and retrieves data called for by a user from the memory to transmit it to the display unit 14.

The display unit 14 provides the data received from the control unit 13 by displaying it on a screen.

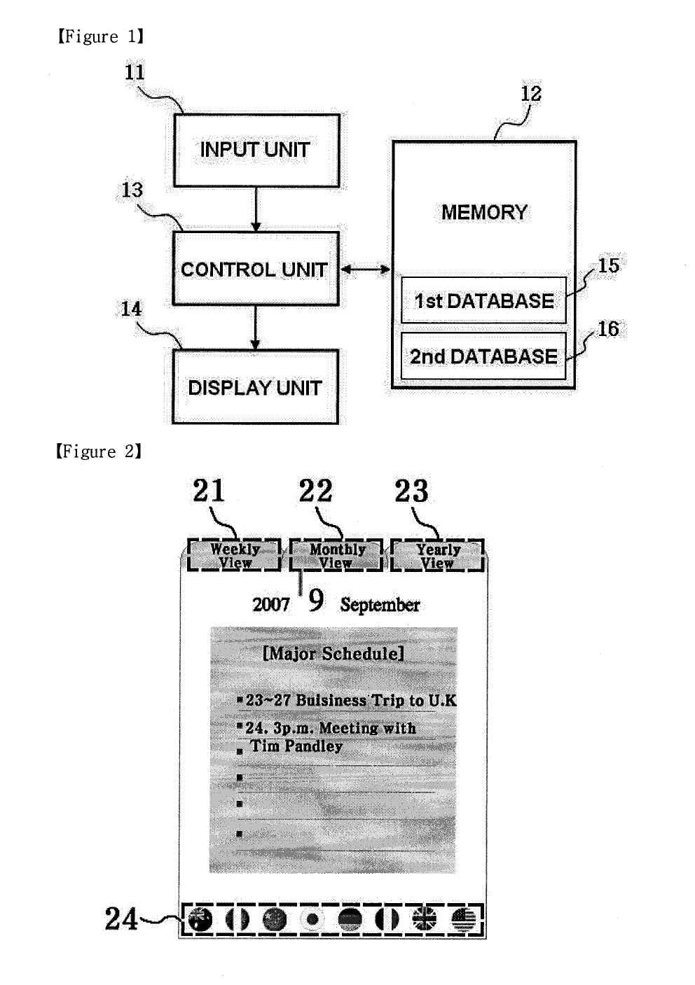

FIG. 2 is a main frame according to an embodiment of the present invention.

The main frame shows a year, a month and major schedules of the month and includes a yearly view tab, a monthly view tab, and a weekly view tab on the upper part of the frame, and icons of the national flag of major countries on the lower part of the frame. The yearly view tab 23, the monthly view tab 22 and the weekly view tab 21 are respectively connected to a yearly, monthly and weekly calendar, and icons of a national flag 24 are for selecting the country's calendar. The major schedules for the month are shown in the center of the frame.

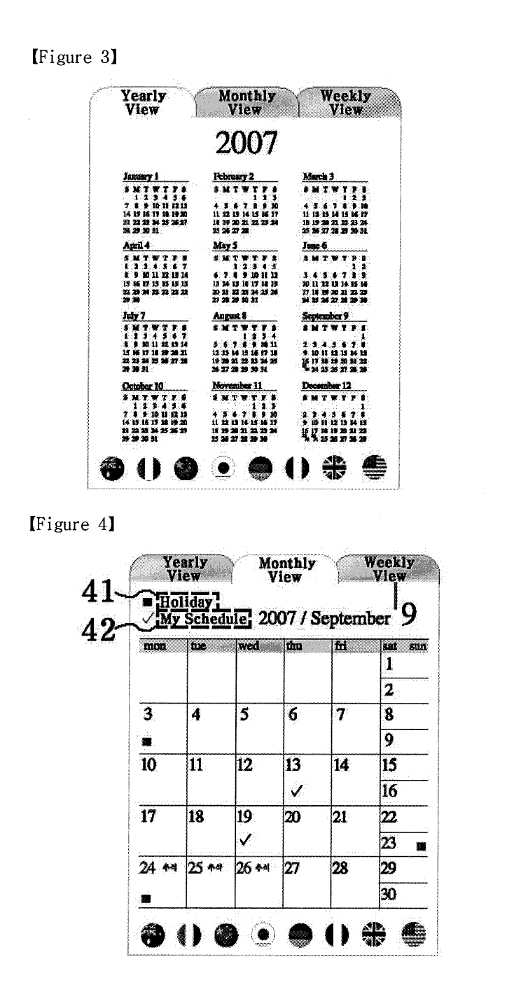

FIG. 3 is a frame of a yearly view tab according to an embodiment of the present invention. Referring to FIG. 3, the frame shows a yearly calendar of a country selected in the main frame in FIG. 2, in which national holidays are easy enough to note since they are marked with different colors.

FIG. 4 is a frame of a monthly view tab according to an embodiment of the present invention. Referring to FIG. 4, the frame shows a monthly calendar of a selected country, and includes an indicator 41 which indicates whether holidays are marked or not and a schedule marker 42 which shows that a user's schedules are stored. The indicator 41 and the schedule marker 42 is included in a corresponding date in order to increase each remarkableness thereof and their details are seen when the corresponding date is selected to connect to a daily view which will be described in FIG. 6.

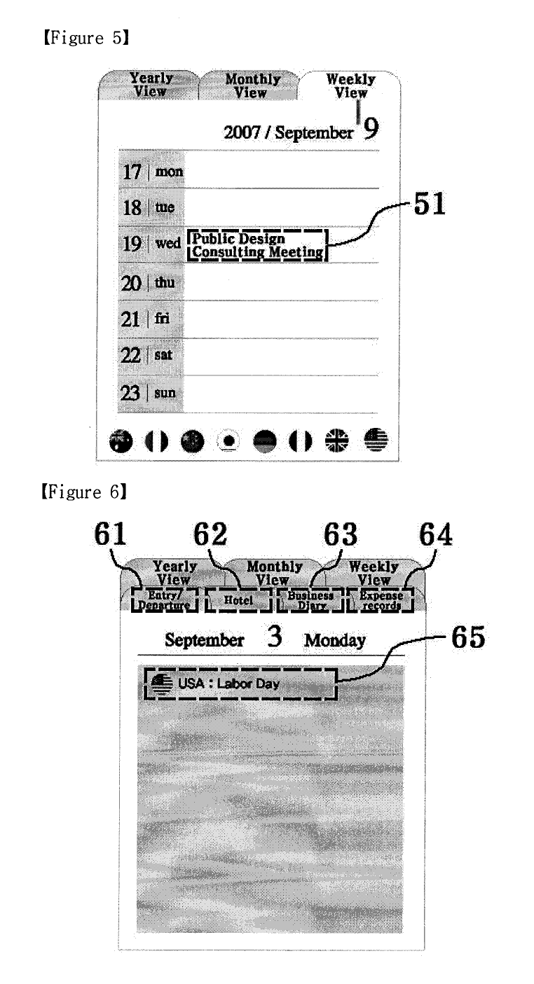

FIG. 5 is a frame of a weekly view tab according to an embodiment of the present invention. Referring to FIG. 5, the frame shows a weekly calendar of a selected country, and displays a schedule 51 planned on the week on the frame.

The example is the one when a calendar of the United States is selected, and the selected country's national flag is excited in colors on the lower portion of each frame in FIG. 3 to 5. In addition, plural number of countries can be selected for those countries' holidays to be displayed in one calendar. In this case, the flags of the selected countries are all excited. Each date in FIG. 3 to 5 is connected to the corresponding date of a daily view.

FIG. 6 is a frame of a daily view tab according to an embodiment of the present invention. Referring to FIG. 6, the frame is displayed when a date in FIG. 3 to 5 is selected to activate connection to the daily view. The daily view includes details of the schedule and information on a national holiday 65 of the date. The schedule can be edited, added, or/and deleted. As shown in FIG. 6, Labor day 65, a federal holiday of the U.S., is marked. There are a entry & departure information tab 61, a hotel information tab 62, a business travel diary tab 63, a business travel expense records tab 64 on the upper portion of the daily view 250, which connect each frame thereof.

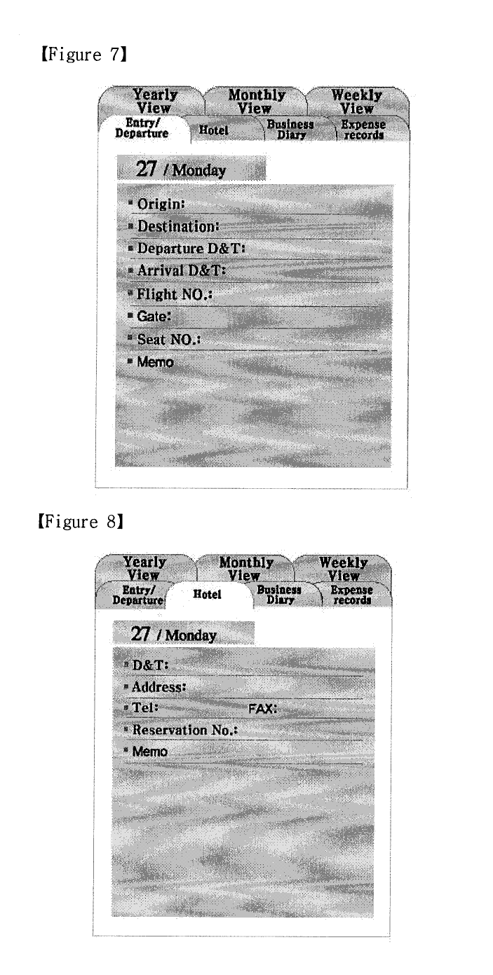

FIG. 7 is a frame of an entry & departure information tab according to an embodiment of the present invention. Referring to FIG. 7, the frame includes more than one kind of information on origin, destination, departure date & time, arrival date & time, flight number, departure/arrival gate number, seat number, and memo. The contents of the frame can be composed according to the nature or the purpose of business travel or visiting.

FIG. 8 is a frame of a hotel information tab according to an embodiment of the present invention. Referring to FIG. 8, the frame includes more than one kind of information on date & time, address, telephone number, facsimile number, reservation number, and memo, and can be made use of for the purpose of reservation for a lodging and the confirmation thereof when one is staying abroad.

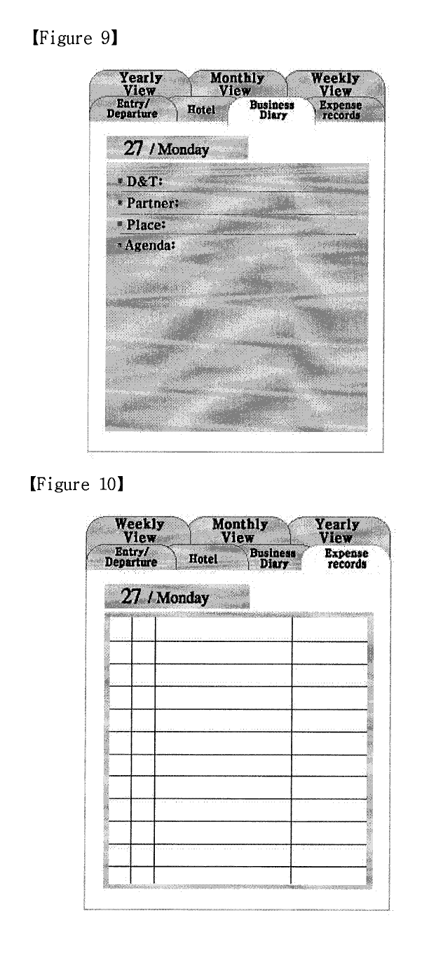

FIG. 9 is a frame of a business travel diary tab according to an embodiment of the present invention. Referring to FIG. 9, the frame includes more than one kind of information on date & time of the business travel, name of meeting partner(s), meeting place, and agenda of the meeting, and can be made use of for the purpose of storing and checking information on a meeting.

FIG. 10 is a frame of a business travel expense records tab according to an embodiment of the present invention. Referring to FIG. 10, the frame includes information on amount of expenses, purpose of expenses, date, etc., and can be made use of for the purpose of calculating business travel expenses.

An international diary system configured like an embodiment described above have calendars of many countries including information on national holidays and functions for the management of business and schedule, and can be applied in information devices such as a mobile phone, laptop computer, PDA, and the like, increasing the convenience of businesspeople or travelers who often travel abroad.

Even though the application is not mentioned, the system can include other information specific and essential for international business and overseas travel by configuring displays and recording means therefor.

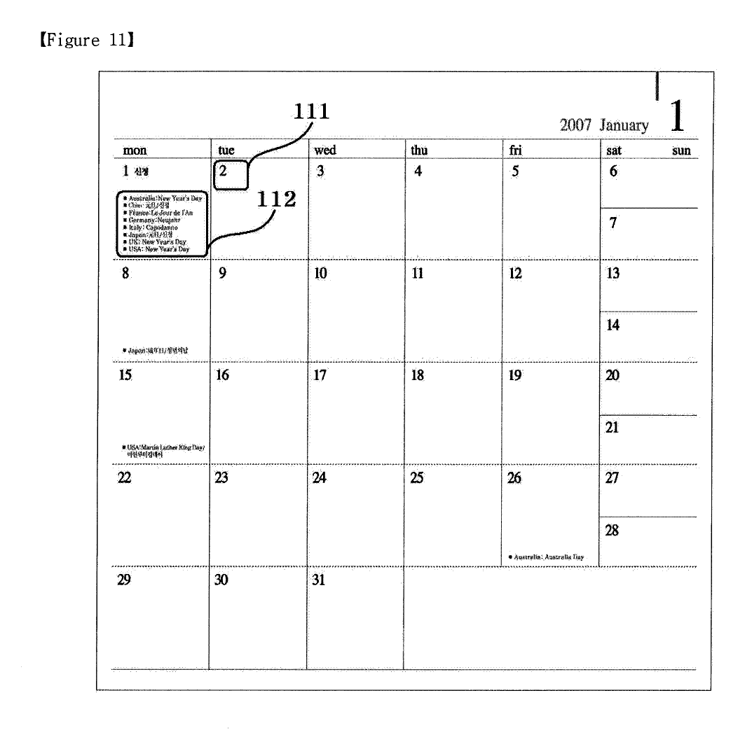

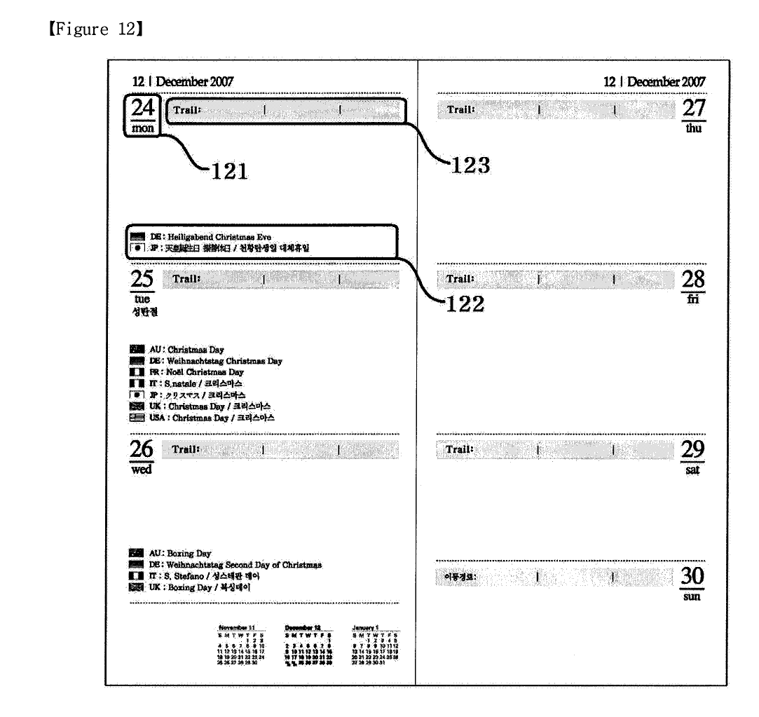

FIG. 11 is an example of a monthly view section according to another embodiment of the present invention. Referring to FIG. 11, the example is the monthly calendar of January of the year 2007. The monthly view display includes a date display portion 111 and a national holiday display portion 112 in each corresponding date section. The date display portion 111 usually adopts the same color that is used in a general calendar, but in some cases, is possibly configured with a indicator, which will be described in a weekly view display of FIG. 12. Since national holidays differ country by country, they all are preferably displayed in one monthly view, thereby promoting a user's convenience. The national holiday display portion 112 displays information on a national holiday with a country's flag or with the name of a country. In other words, The national holiday display portion 112 can vary the display of a national holiday depending on the size of the diary manufactured.

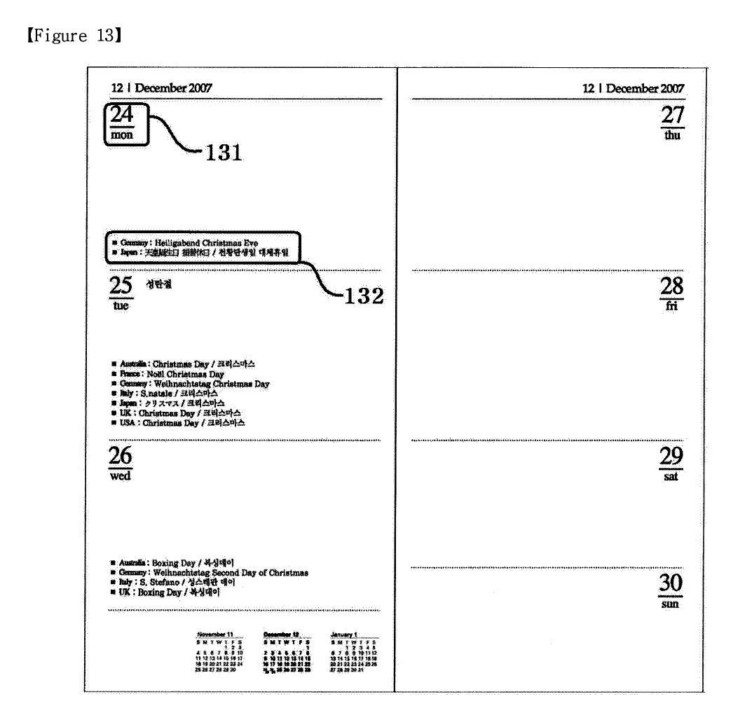

FIGS. 12 to 13 are examples of a weekly view section according to another embodiment of the present invention. Referring to FIGS. 12 to 13, the examples are the weekly calendars of 24th to 30th of December of the year 2007. The weekly view display according to FIG. 12 includes a national flag in a national holiday display portion 122, and the weekly view display according to FIG. 13 does not include a national flag in a national holiday display portion 132. The inclusion or exclusion may be chosen depending on the size, the cost, or the use of the diary to be manufactured.

A date display 121, 131 of the weekly view display according to FIGS. 12 to 13 is for setting an indicator in order to mark the national holidays of each country. As an example of the indicator, the color of an underline of a date can be set so as to identify which color is for which country's national holidays. In other words, as for internationally common holidays both date and the underline can be red; otherwise as for national holidays of other countries different from domestic holidays only the underline can be mark with red.

A national holiday display 122, 132 of the weekly view display according to FIGS. 12 to 13 can be marked by adopting different colors for each country, thereby increasing the identification of the national holidays of each country. In addition, a trail display 123 is for planning or recording of user's travel trail by country or by region. The mark to be adopted in the trail display 123 can be set according to the purpose of the travel.

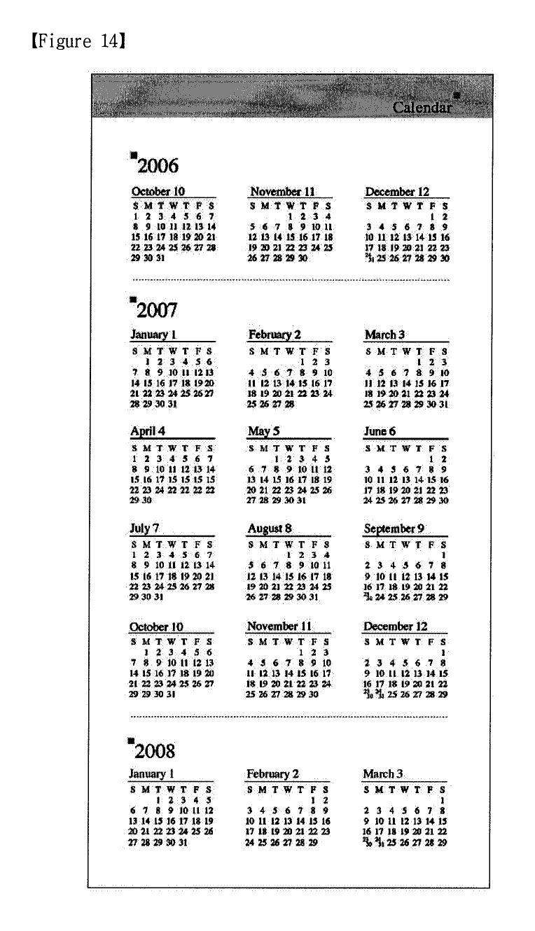

FIG. 14 is an example of a yearly view section according to another embodiment of the present invention. Referring to FIG. 14, the yearly view display looks like one in a general diary, but the indicator in the date display 121, 131 of FIGS. 12 to 13 can be marked in order to identify yearly international holidays at once.

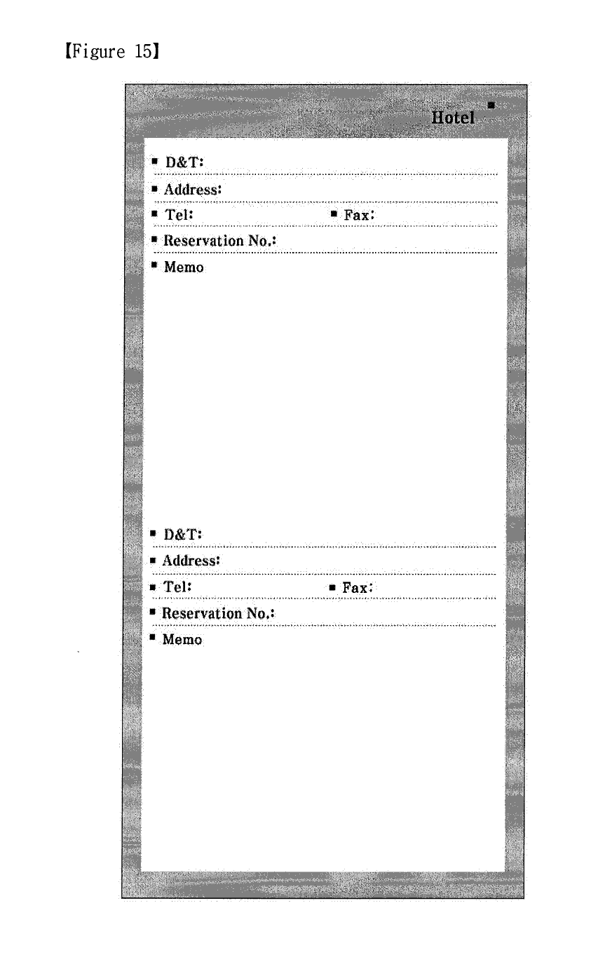

FIG. 15 is an example of a hotel information section according to another embodiment of the present invention. Referring to FIG. 15, the hotel information display includes at least one item of date & time, address, telephone number, facsimile number, reservation number, and memo. The hotel information display is for recording of indispensable information for overseas travel, thereby promoting a user's safe and convenient travel.

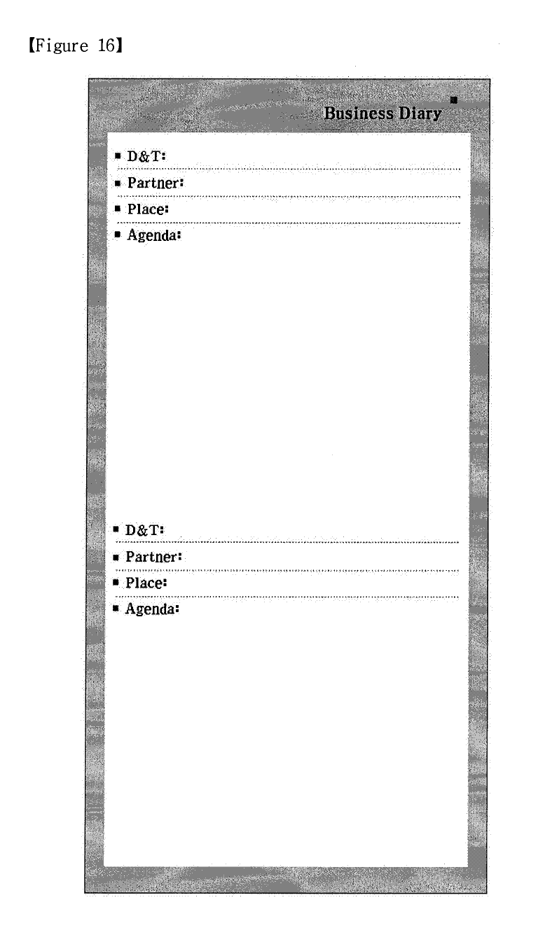

FIG. 16 is an example of a business travel diary section according to another embodiment of the present invention. Referring to FIG. 16, the business travel diary display includes at least one item of date & time of the business travel, name of meeting partner(s), meeting place, and agenda of the meeting. The business travel diary display is for realtime recording of information on a meeting whenever there is a meeting, thereby providing clear and exact information on the meeting.

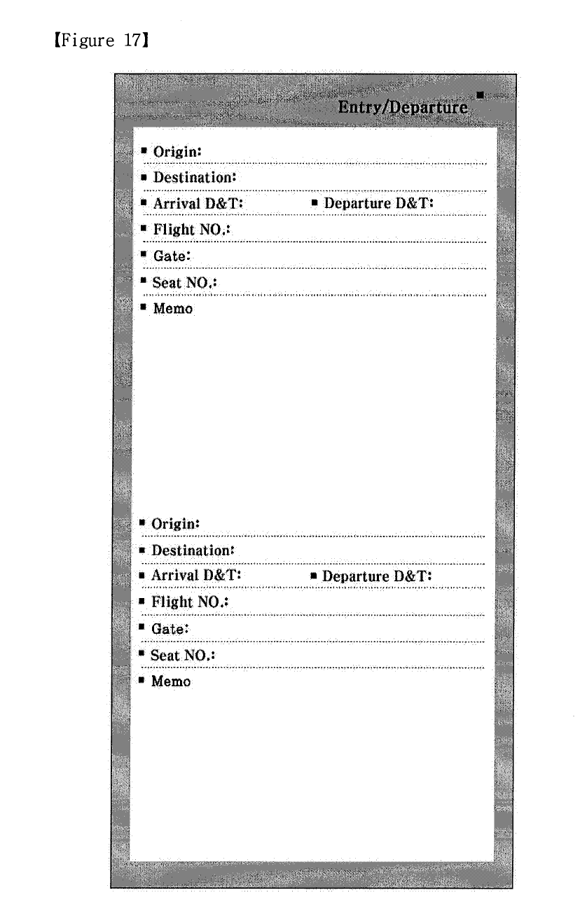

FIG. 17 is an example of an entry & departure information section according to another embodiment of the present invention. Referring to FIG. 17, the entry & departure information display includes at least one item of origin, destination, departure date & time, arrival date & time, flight number, departure/arrival gate number, seat number, and memo. The entry & departure information display is for realtime recording of information on the moving trail in a travel, thereby providing clear and exact information on the moving trail when referring to the information after the travel.

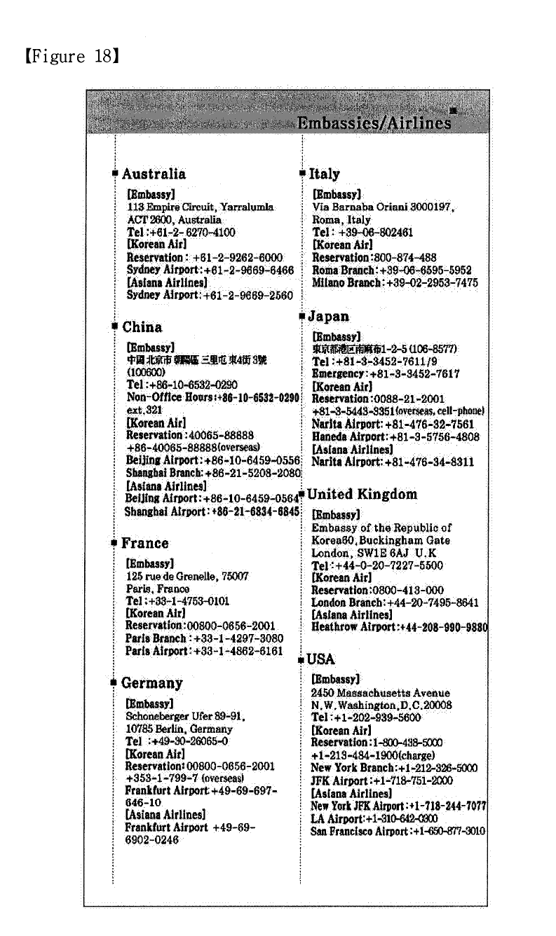

FIG. 18 is an example of an embassies & airlines information section according to another embodiment of the present invention. Referring to FIG. 18, the embassies & airlines information display is for providing information on national embassies abroad and on major domestic airlines' branches in a referring country, thereby securing a route to contact with in case of an emergency and furthering safe and peaceful journey.

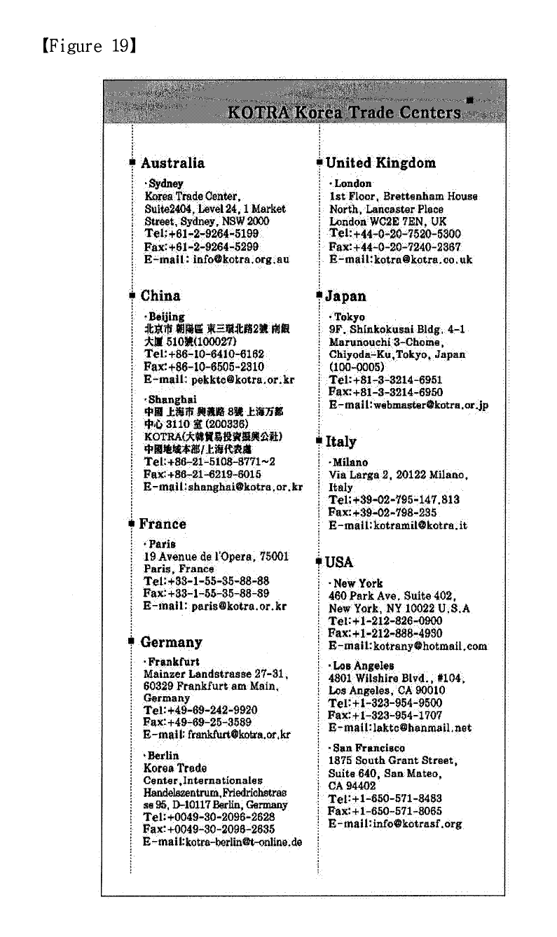

FIG. 19 is an example of a KOTRA Korea Trade Centers information section according to another embodiment of the present invention. Referring to FIG. 19, the KOTRA Korea Trade Centers information display is for providing a business traveller with information on KOTRA (Korea Trade-Investment Promotion Agency) Korea Trade Centers in other countries clearly at a glace, thereby helping get governmental or non-governmental support to advance a international trade, business-to-business investment, or industrial/R&D cooperation.

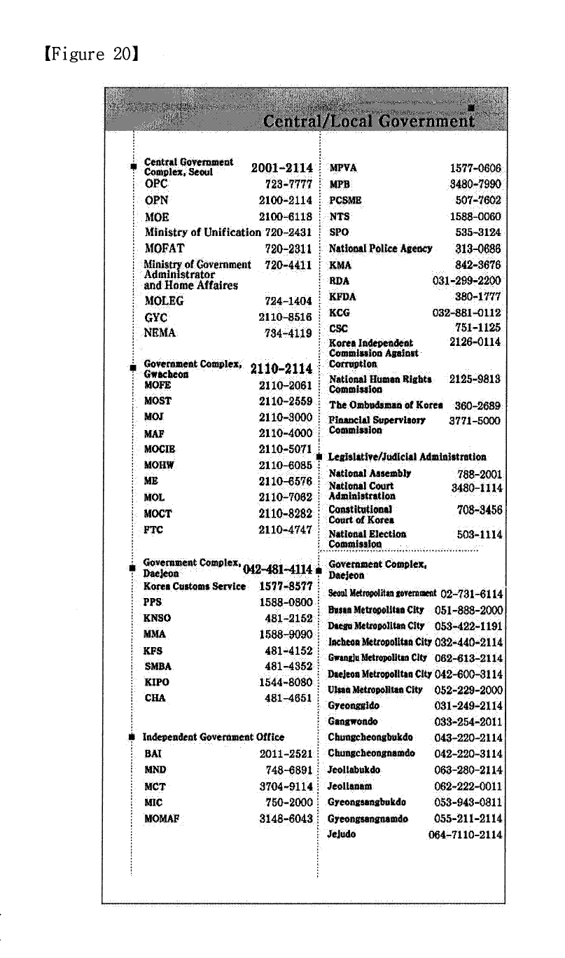

FIG. 20 is an example of a national central & local government information section according to another embodiment of the present invention. Referring to FIG. 19, the national central & local government information display is for the use of a overseas traveller when the traveller should have a contact with a national central government or a local government of the country where the traveller stays. Since a business traveller often operates his/her business in the foreign country being linked with the foreign country's various organizations and sometimes has a contact with the country's central or local government related to the traveler's trade or business, the national central & local government information display is handy enough for such a business traveller.

Besides, even though not shown in FIGS. 11 to 20 according to another embodiment of the present invention, other sections can be included as well for displaying or recording many other information essential to overseas trip.

Although the present invention has been described with reference to several preferred embodiments, the description is illustrative of the invention and is not to be construed as limiting the invention. Various modifications and variations may occur to those skilled in the art, without departing from the scope of the invention as defined by the appended claims.

1. An international diary system, comprising:
an input unit for a user to select a frame and input data;
a memory to store an international diary program and data inputted by a user, including a first database to store yearly, monthly, weekly, and daily calendars with a mark of national holidays by country and inputted schedule, and a second database to store information on business travel of a user;
a control unit to execute said program and retrieve data called for by a user from said memory; and
a display unit to display said retrieved data on the screen.

2. The international diary system of claim 1, wherein said information on business travel includes entry & departure information relevant to a visiting country, hotel information relevant to a lodging, a business travel diary relevant to information on a business trip, and a business travel expense record for the calculation thereof.

3. The international diary system of claim 1, wherein said yearly, monthly, weekly, and daily calendars with a mark of national holidays by country, which are stored in said first database, have national flag icons on the lower part thereof, at least one of which are excited with colors when being selected.

4. The international diary system of claim 3, wherein said monthly calendar with a mark of national holidays by country, which is stored in said first database, includes an indicator for showing a holiday and a schedule marker for showing a schedule.

5. An international diary, comprising:
a monthly view section which includes a date display portion and a national holiday display portion in each corresponding date section; and
a weekly view section which includes a date display portion and a national holiday display portion in each corresponding date section, wherein said date display portion is possible to have an indicator for identifying a holiday by country and said national holiday display portion is possible to have at least one of a national flag and a name of the holiday.

6. The international diary of claim 5, wherein said indicator, included in said date display portion of said weekly view section, shows information on a national holiday by country by changing a color of an underline of a corresponding date.

7. The international diary of claim 6, wherein said indicator, when a national holiday of a foreign country is the same with a national holiday of home country, serves to mark both the date and the underline with red; otherwise, in case of a national holiday of a foreign country, mark only the underline with red.

8. The international diary of claim 7, wherein said weekly view section further includes a trail display for a user to plan or record the user's travel trail by country or by region.

9. The international diary of claim 8, further comprising a yearly view section which includes a date display portion with said indicator marked.

10. The international diary of claim 9, further comprising a hotel information section which includes at least one item of date & time, address, telephone number, facsimile number, reservation number, and memo.

11. The international diary of claim 10, further comprising a business travel diary section which includes at least one item of date & time of a business travel, name of meeting partner(s), meeting place, and agenda of the meeting.

12. The international diary of claim 11, further comprising an entry & departure information section which includes at least one item of origin, destination, departure date & time, arrival date & time, flight number, departure/arrival gate number, seat number, and memo.

13. The international diary of claim 12, further comprising an embassies & airlines information section which provides information on national embassies and major domestic airlines' branches located in foreign countries.

14. The international diary of claim 13, further comprising a KOTRA Korea Trade Centers information section which provides information on KOTRA Korea Trade Centers abroad.

15. The international diary of claim 14, further comprising a national central & local government information section which provides information on national central & local government of a relevant country.
